(19) United States
(12) Patent Application Publication
(10) Pub. No.: US 2011/0111611 A1
(43) Pub. Date: May 12, 2011

(54) STRAP CONNECTION DEVICE FOR ELECTRICAL CONDUCTIVITY

(76) Inventor: Ignacio ZAMORA GÓMEZ, Villaviciosa De Odon (Madrid) (ES)

(21) Appl. No.: 12/877,143

(22) Filed: Sep. 8, 2010

(30) Foreign Application Priority Data
Sep. 30, 2009 (ES) P200930767

(51) Int. Cl. H01R 13/62

(52) U.S. Cl. 439/180

(57) ABSTRACT

The strap (2) comprises a conducting cable whose ends are fixed to each individual conducting structural element (1) by means of each individual connection device for providing electrical continuity among the conducting structural elements (1). It is characterized in that the connection device comprises a connector (3) of the quick-release type which includes two pluggable parts (4 and 5) for carrying out the connection/release between both pluggable parts, in such a way that one of said pluggable parts is provided with fastening means to one of the elements (1), while the other pluggable part comprises a securing element to one of the ends of the cable, in order to permit the quick release of the cable with respect to the elements (1). It reduces time and cost of assembly/removal of the straps (2).

Applicable in aeronautics for connecting elements (1) with relative movement and which have difficult accessibility between them, permitting the conduction of possible lightning striking an aircraft.

### OBJECT OF THE INVENTION

The present invention relates to a device that makes it possible to perform the connection of straps of different conducting structural elements to establish the electrical conductivity between said conducting structural elements. Its object is to make it possible to carry out the connection/disconnection of the straps in respect of the conducting structural elements to which they are connected in a quick and effective manner to considerably reduce the assembly and maintenance time thereof.

The invention is applicable in any industrial sector in which it is required to connect conducting structural elements to each other by means of straps in order to maintain electrical conductivity thereof, and more specifically it is applicable to those conducting structural elements wherein there is relative movement, hence it is required to interconnect them by means of straps that allow the relative movement between them. More particularly, the invention is applicable in the aeronautic industry to the straps utilized to conduct the lightning that may strike an aircraft.

### BACKGROUND OF THE INVENTION

In the aeronautics field, in order to protect aircraft against lightning that may strike it, the electrical conducting structural elements are interconnected to each other to maintain electrical conductivity. It enables the electrical current from lightning that strikes an aircraft to circulate therethrough to exit to the exterior again avoiding any major damage to the aircraft.

This interconnection between the contiguous structural elements is carried out by the elements themselves used for the fastening thereof, but in the event wherein the structural elements show relative movement to each other, or in the event wherein the number of structural fastening elements does not guarantee sufficient conductivity, the continuity of electrical conductivity is carried out by interconnecting said structural elements by means of straps that permit the relative movement of displacement and/or rotations between the structural elements to be carried out under severe environmental conditions and wide pressure and temperature ranges (70° C. to −50° C. cycles in each flight), in areas with a high probability of corrosion due to pollutants and unsuitable environments that could impair the functioning of the fastening of the strap to the structural elements.

Typical examples of these connections are landing gear bays, aerodynamic fairings, flaps, rudders and other aircraft control surfaces, that have contact with the external environment permanently, or at least during certain stages of the flight.

For this purpose, the straps are comprised of braided cables, for example, whose ends are fastened to a connecting device comprised of a metal sheet provided with a through hole which is fastened to the conducting structural elements by means of screws, nuts and washers, in a way similar to any other type of mechanical structural fastening.

Consequently, the connection of the straps to the structural elements requires several elements (screw, nut, washers, straps) to be installed in the correct order and position. The specified clamping torque defined in the assembly plan or in the applicable regulation should also be applied.

Because the electrical conductivity must be carried out between metallic elements in contact, it is not possible for them to be already protected against corrosion, as this would make said electrical continuity impossible or difficult.

Thus, the assembling process of the connection finishes by applying suitable protective products, such as sealants and special varnishes, to achieve surface electrical insulation of the metallic elements of the fastening against the corrosive environment wherein the aircraft will operate.

This whole configuration determines that both in the aircraft construction and in the case where it may be necessary to disassemble certain elements, as well as to maintain strap, excessive time is required to carry out both the connection and disconnection thereof. This increases the cost of said processes and additionally, in some cases the disassembly and maintenance operation could become overly complicated when it is difficult to have access to the screws, nuts, etc.

Furthermore, if the number of fastening elements to be used in each assembly is very high, the time used in the assembly and disassembly is greatly increased, apart from increasing the possibility of error in the mentioned placement and connection.

In addition, to carry out both the assembly and disassembly, it is necessary to perform the application or removal of the anti-corrosion products on the metallic surfaces of the fastening elements, as well as the corresponding curing process, which implies additional working and waiting time.

On the other hand, in the case of fastening structural elements with relative movement, their intrinsic rigidity of the fastening by the straps tends to cause the cables to break because of the fatigue of the strands that form the braided strap.

In the case that the orientation of the connection is not actually optimal in relation to the kinematic trajectories, the fatigue effect can appear relatively early during the working life of the aircraft.

As previously mentioned, it is very desirable to obtain a connection device of the straps making it possible to solve all the aforementioned drawbacks.

### DESCRIPTION OF THE INVENTION

To solve the drawbacks and attain the aforementioned aims, the invention has developed a new device that makes it possible to carry out the connection of the electrical conductivity strap in a quick and effective manner with considerable time saving in the assembly/disassembly thereof.

For that purpose, the strap along with the ones provided for in the state of the art comprising a braided conductor cable, whose ends are fastened to each one of the connecting devices, through which connecting to each one of the conducting structural elements to provide electrical continuity between said conducting structural elements. The connection area of the connecting devices on the structural elements, are covered a posteriori by a protective layer providing the electrical insulation necessary in the connection.

The main novelty of the invention resides in the fact that the connecting device is comprised of a connector of the quick-release type comprising two pluggable parts and a spring-assisted displaceable mechanism, to carry out the connection/release between both pluggable parts. One of the pluggable parts is provided with fastening means to one of the conducting structural elements, whereas the other pluggable part comprises a clamping element to one of the cable ends, to allow the quick release of the cable in respect of the conducting structural elements.

In order to facilitate electrical conductivity between the pluggable parts of the quick-release connector, one embodiment of the invention envisages that the coupling surfaces between both pluggable parts have a conical shape to ensure the contact thereof and consequently electrical conductivity.

Another embodiment of the invention envisages that the pluggable parts of the quick-release connector have a cylindrical shape with suitable dimensions and tolerances that ensure the electrical contact and conductivity.

On the other hand, it can be noted that the pluggable parts of the quick-release connector have outside portions that, in the connected position, face each other and are separated at a certain distance, such that at this distance a water-tight sealing gasket is arranged as to close the fastening between the two pluggable parts.

In another embodiment of the invention the outside portions of the pluggable parts in the connected position face each other and are in contact, in such a way that a water-tight sealing gasket is arranged between both pluggable parts.

Thus, the invention envisages the need to incorporate a water-tight sealing gasket, which can be of a retractable type when heat is applied, or on the contrary, an elastic gasket is adapted to the sealing area to carry out this function.

In order to fasten the cable ends to one of the pluggable parts, the corresponding clamping element is comprised of a rear extension of the pluggable part which includes folding-clamping pins on the cable, so that upon folding and clamping said pins the fastening of the cable end on the clamping element is carried out. It is also possible that the clamping element comprises a rear extension of the pluggable part which includes a cable housing hole wherein the cable is held by a fastener that goes through the extension and the cable.

In the preferred embodiment of the invention the clamping element of one of the cable ends of a pluggable part is determined as extending from the displaceable mechanism of the quick-release connector, in such a way that this structure makes it possible to carry out the release by pushing the cable in the axial direction.

The fastening means of one of the pluggable parts to one of the conducting structural elements are comprised of an element defined by an extension of the pluggable part, an extension including at least two holes fastened thereto by a through-element that goes through said hole and the conducting structural element. The possibility that the fastening means are defined by a threaded hole cut into said pluggable part is also contemplated, in such a manner that a screw that passes through a hole cut in the structural element in order to fasten the same is threaded in said hole. In addition, in another embodiment of the invention the pluggable part is provided with a threaded extension arranged to go through a hole cut in the conducting structural element, projecting there beyond, in order to allow performing the threading of the nut in the threaded extension and thus performing the clamping of the pluggable part to the conducting structural element.

As mentioned before, the invention has been specially conceived to be applicable in the aeronautics industry, to the straps that are conventionally envisaged to establish the electrical conductivity between the structural elements that comprise it and thus conduct the lightning that may impact the aircraft, and more specifically, the invention is applied on connecting straps between conducting structural elements between which there is relative movements of an aircraft as previously mentioned.

Consequently, in the case wherein the direction of the connection of the strap ends to the conducting structural elements, is not optimal, in relation to the kinematic trajectories produced between the displaceable conducting structural elements, the fatigue effect can appear relatively soon in the aircraft working life, for which purpose the invention envisages that the coupling tolerance of the pluggable parts of the quick connector is such that it allows a slight angular relative displacement between them, in order to avoid twisting the conductor cable, in such a way that during the relative movement the angular displacement is produced between the pluggable parts in terms of the twisting that the strap may be sustaining, so as to avoid the formation of said twist and consequently prolonging the working life thereof.

The described shape considerably facilitates the installation/uninstallation processes of the electrical conductivity connections that must be carried out among many elements of the aircraft, either during the initial assembly thereof, or during the subsequent maintenance operations carried out during its working life. This is because of the quickness in which the connection/disconnection of the straps having quick-release is performed.

To carry out the initial assembly, one of the pluggable parts is fastened onto the conducting structural elements to be connected, then they are interconnected by means of a strap whose ends include the other pluggable part, in such a way that the connection/disconnection of the strap is carried out in the shortest time, since only two movements are needed, one for each one of the strap ends, and then the fastening is sealed/unsealed acting over the mentioned sealing gasket, and this considerably reduces the assembly/disassembly costs.

Hereinafter to provide a better understanding of this specification, and forming an integral part thereof, a series of figures in which the object of the invention has been represented with an illustrative and non-limitative manner is attached.

### BRIEF DESCRIPTION OF THE FIGURES

FIG. 1 shows a section view of an embodiment of the device of the invention wherein the pluggable parts are disconnected.

FIG. 2 shows a view equivalent to the previous figure wherein the pluggable parts are connected.

FIG. 3 shows a section view of another embodiment with the pluggable parts connected.

FIG. 4 shows a third embodiment wherein the pluggable parts are connected.

FIG. 5 shows a fourth embodiment wherein the pluggable parts are connected and their contact surface is conical, unlike the examples of the previous figures wherein the contact surface is cylindrical.

### DESCRIPTION OF THE PREFERRED EMBODIMENTS

A description of the invention based on the aforementioned figures is made hereinafter.

To connect two conducting structural elements 1, so that there is electrical conductivity between them, the use of a braided strap 2 whose ends are fastened to each one of the conducting structural elements is envisaged. 1 it is desirable to establish conductivity there between. This all done by means of a quick-release type connector 3 comprised of two pluggable parts 4 and 5, in such a way that one of the pluggable parts 4 is fastened beforehand to one of the conducting structural elements 1, e.g. a female pluggable part 4 and the other pluggable part 5 are connected to the strap ends 2, e.g. a male pluggable part 5.

To carry out the clamping of the female pluggable part 4 to the structural element 1, it is envisaged that the rear end of said female pluggable part 4, has a rear extension 20 provided with two holes through which it is fastened by means of a through-element that goes through said holes. The through-elements, for example, can be screws which are fastened by the corresponding washers and nuts.

A displaceable mechanism 6 assisted by a screw is provided for in the inside of the pluggable part in order to make it possible to connect/release between both pluggable parts 4 and 5. For this purpose, the female pluggable part 4 is equipped with a channel 8 cut into the inside surface that is complementary to some spheres 9 that are housed in holes cut into the male pluggable part 5, in such a way that said spheres 9 can project beyond the surface outside of the male pluggable part 5 but without it being possible to be removed through its outside part, while it is possible to do so through its bottom part. It has been envisaged on the displaceable mechanism 6 a second perimeter channel 10, which by action of the spring 7 is maintained separate from the spheres 9 hence being pushed toward the outside projecting beyond the male pluggable part 5. In this situation, by pressing the displaceable mechanism 6, the spheres 9 coincide with the second perimetric channel 10, wherein they are housed hiding from the outside part of the male pluggable part 5. This situation allows for the introduction of said pluggable part 5 in the inside of the female pluggable part 4 such that by releasing the displaceable mechanism 6, again, the action of the spring 7, its axial displacement is produced toward the rear part, being the spheres 9 pushed toward the outside by the displaceable mechanism 6, such that the spheres are housed in the channel 8 cut into the inside surface of the female pluggable part 4, avoiding displacement of both pluggable parts. This produces the fastening and connection between the two pluggable parts 4 and 5.

The allowed movement of the displaceable mechanism 6, is delimited by a housing 11 provided for on the male pluggable part 5, wherein a stopper 12 is housed, that is integral to the displaceable mechanism 6, so that the stopper 12 makes contact with the rear part of the housing 11 by the action of the spring 7 in the interlocking position in the inside of the female pluggable part 4, while the stopper 12 makes contact with the front part of the housing 11 in the unlocking position in which the spheres 9 are housed in the second perimetric channel 10, acting on the displaceable mechanism 6 overcoming the action of the spring 7.

To perform the clamping of the male pluggable part 6 to the strap 2, it is envisaged that said male pluggable part 6 comprises a rear extension 13 provided with a hole 14 in which the cable end of the strap 2 is housed. The restraint is performed by means of a fastener 15 going through the extension 13 and the strap 2.

The disclosed structure makes it possible to perform the movement of the displaceable mechanism 6 by means of the acting of the strap 2, pulling or pushing thereof in an axial direction to perform the disconnection/connection.

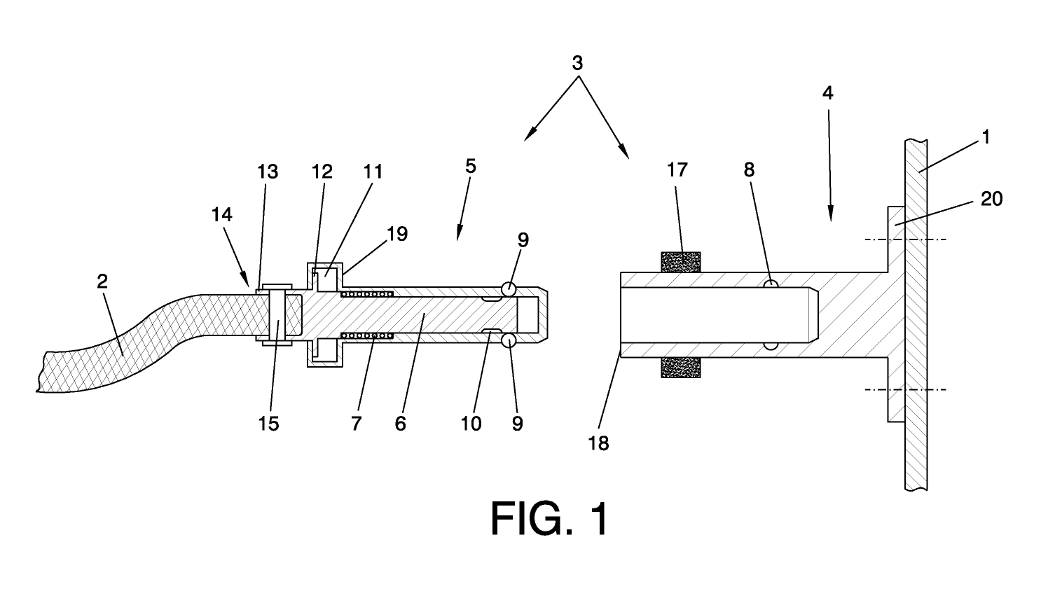

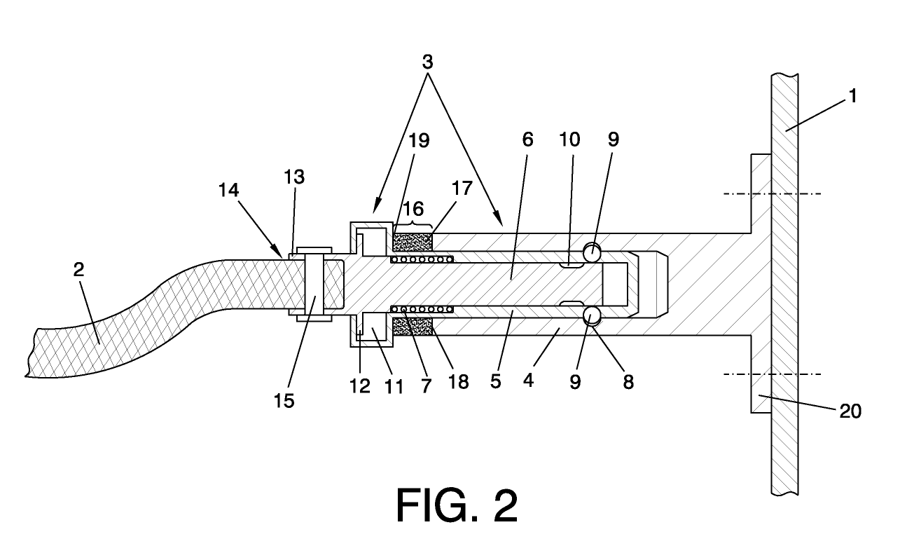

The shape described in FIG. 1 is such that when in the position in which the pluggable parts 4 and 5 are connected, they have outside surfaces 18 and 19, which in the connected position face each other and are separated at a certain distance 16, as shown in FIG. 2 in such a way that said distance is taken up by a water-tight sealing gasket 17 that is initially arranged on the outside of the female pluggable part 4, in such a way that as the connection between both parts is carried out, the movement of the water-tight sealing gasket 17 is performed until it is placed at in the distance 16, producing the gasket sealing of the fastening between both pluggable parts.

The water-tight gasket 17 can be of thermo-shrinkable type or an elastic gasket adapted to the space 16 by its own elastic nature.

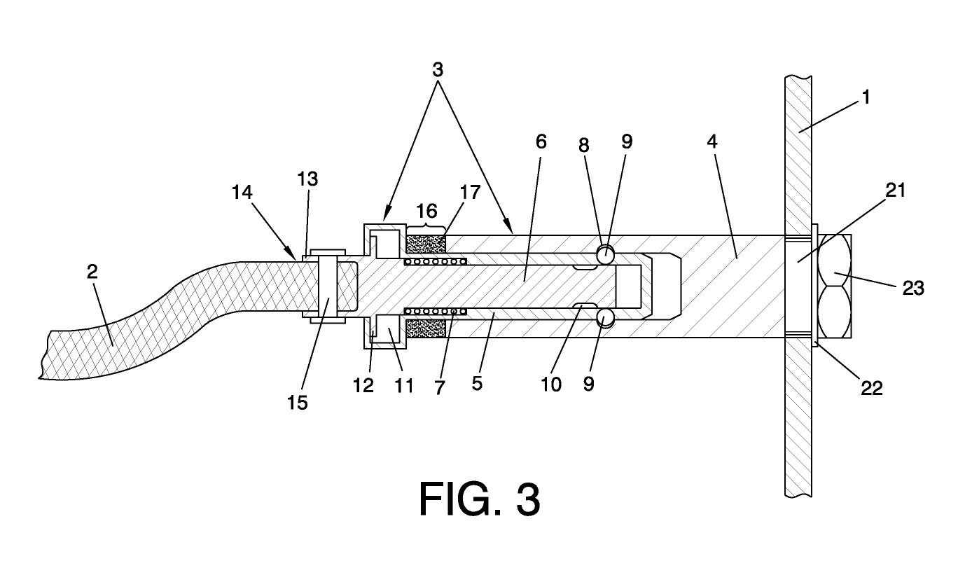

FIG. 3 shows an embodiment similar to the one represented in FIGS. 1 and 2, but with the difference that in this case the fastening of the female pluggable part 4 to the conducting structural element 1, is performed by means of a threaded extension 21 that goes through the conducting structural element 1 and to which it is fastened by means of a washer 22 and nut 23.

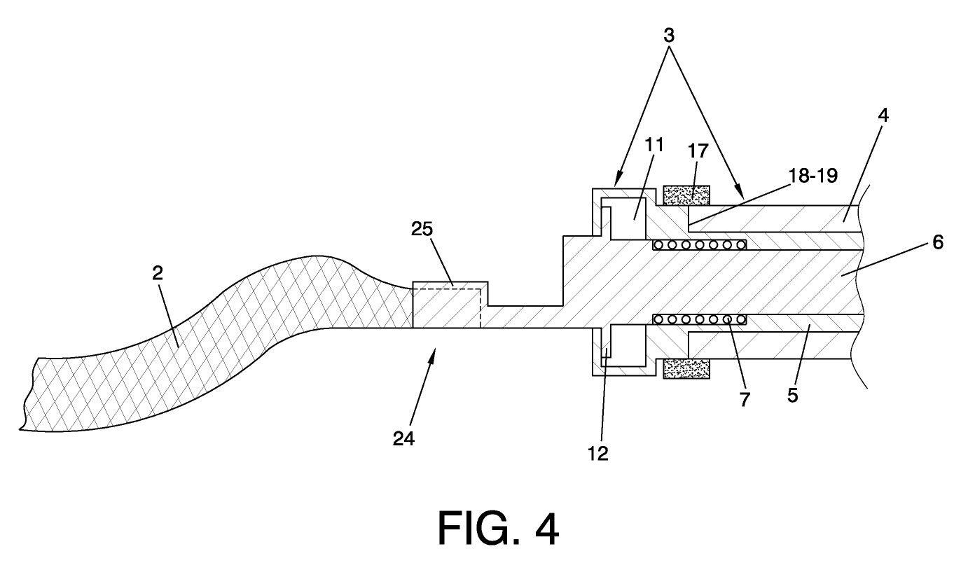

FIG. 4 shows another embodiment of a variant of the fastening of the strap end 2 on the displaceable element 6. In this case, said fastening is performed by means of a rear extension 24 of the pluggable part comprising folding-clamping pins 25 on the strap 2, in a similar way as the fastening of electrical cables to the conventional connection terminals. In this case, the movement of the mechanism 6 is also carried out by pulling or pushing the strap 2 in the axial direction in order to perform the connection/disconnection.

In the example of FIG. 4, the outside surfaces 18 and 19, in the connected position between the pluggable parts 4 and 5, face each other and are in contact in such a way that on said fastening the water-tight sealing gasket 17 is arranged superimposed on the outside of the pluggable parts 4 and 5.

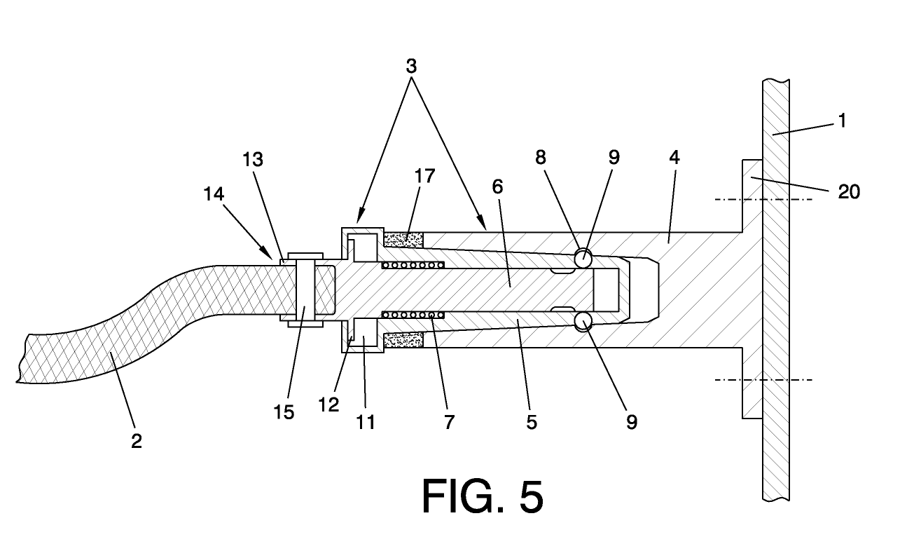

All of the embodiments described so far, have a cylindrical shape of the pluggable parts 4 and 5, but this shape can be modified, e.g. the case represented in FIG. 5 wherein the coupling surfaces of the pluggable parts 4 and 5 have a conical shape that may determine a better contact surface between both pluggable parts, and consequently, a better electrical conductivity. In any of the cases, i.e. the case wherein the pluggable parts have a conical configuration and wherein said shape is cylindrical, they must have the suitable tolerances to guarantee contact and consequently electrical conductivity.

However, in this case it should be pointed out that because the invention is envisaged, as disclosed in previous paragraphs, in order to conduct lightning having high intensity the circulation of said current producing a warming that determines the expansion of the pluggable parts 4 and 5, which guarantee electrical conductivity.

In any of the cases, moreover said tolerances provided for the pluggable parts 4 and 5 are suitable in such a way as to make it possible for there to be a certain revolving relative movement between both, so as to provide a greater degree of freedom to the assembly, by allowing the rotation of the male pluggable part on the female pluggable part 4 making it possible to reduce the tensions that may be produced when the conducting structural elements 1 have relative movement therein, as it has been described in the description of the invention.

According to the carried out description that has been made it is understood that the female pluggable parts 4 may be mounted and fastened beforehand on the conducting structural elements 1 and in turn protected against corrosion, such that with two movements each one of the strap ends 2 is installed onto the female pluggable parts 4 of the conducting structural elements 1 that are to be joined together. This considerably facilitates the assembly/disassembly of the straps 2 reducing considerably operating times, with the subsequent economic saving that this implies.

On the other hand, the fact that the conducting structural elements may be already installed beforehand on the structural elements without practically requiring any additional operations, allows time to be saved in the subsequent production steps and in the final assembly lines.

Likewise, time saving is produced in the maintenance operations, as the assembly and disassembly of these elements can be carried out in a much easier and quicker manner.

1. STRAP CONNECTION DEVICE FOR ELECTRICAL CONDUCTIVITY, wherein the strap (2) comprises a conductor cable, whose ends are fastened to each one of the connection devices, by which they are connected to each one of the conducting structural elements (1) in order to provide electrical continuity between said conducting structural elements (1); is characterized in that the connection device is comprised of a quick-release type connector (3) comprising two pluggable parts (4 and 5) and a displaceable mechanism (6) assisted by a spring (7), in order to carry out connection/release between both pluggable parts; one of the pluggable parts comprising fastening means to one of the conducting structural elements (1), while the other pluggable part comprises a clamping element to one of the cable ends, in order to allow the quick release of the strap (2) with regard to the conducting structural elements (1).

2. STRAP CONNECTION DEVICE FOR ELECTRICAL CONDUCTIVITY, according to claim 1, characterized in that the pluggable parts (4 and 5) of the quick-release connector (3) have a conical shape in their coupling surfaces to guarantee the contact between them and the electrical conductivity.

3. STRAP CONNECTION DEVICE FOR ELECTRICAL CONDUCTIVITY, according to claim 1, characterized in that the pluggable parts (4 and 5) of the quick-release connector (3) have a cylindrical shape with suitable dimensions and tolerances in order to ensure the contact and electrical conductivity between them.

4. STRAP CONNECTION DEVICE FOR ELECTRICAL CONDUCTIVITY, according to claim 2, characterized in that the pluggable parts (4 and 5) of the quick-release connector (3) have outside surfaces (18 and 19) which in the connected position face each other and are separated at a certain distance (16), wherein a water-tight sealing gasket 17 of the pluggable parts (4 and 5) is provided for.

5. STRAP CONNECTION DEVICE FOR ELECTRICAL CONDUCTIVITY, according to claim 2, characterized in that the pluggable parts (4 and 5) of the quick-release connector (3) have outside surfaces (18 and 19) which in the connected position face each other and are in contact, wherein a water-tight sealing gasket (17) of the pluggable parts (4 and 5) is provided for.

6. STRAP CONNECTION DEVICE FOR ELECTRICAL CONDUCTIVITY, according to claim 5, characterized in that sealing gasket (17) is selected from a gasket of thermo-shrinkable type and an elastic gasket.

7. STRAP CONNECTION DEVICE FOR ELECTRICAL CONDUCTIVITY, according to claim 1, characterized in that the clamping element to one of the cable ends of a pluggable part, is comprised of an element selected between a rear extension (24) of the pluggable part which comprises folding-clamping pins (25) on the cable, and a rear extension (13) of the pluggable part, which comprises a cable housing hole (14) wherein the cable is restrained by means of a fastener (15) which goes through the extension (13) and the cable.

8. STRAP CONNECTION DEVICE FOR ELECTRICAL CONDUCTIVITY, according to claim 1, characterized in that the fastening means of one of the pluggable parts to one of the conducting structural elements (1), is comprised of one element selected between a extension (20) of the pluggable part, which is provided with at least one hole through which it is fastened by means of a through-element which goes through said hole and the conducting structural element (1); a threaded hole cut into said pluggable part wherein the screw is threaded which goes through a threaded hole in the structural element (1); and a threaded extension (21) of the pluggable part wherein a nut (23) is threaded by going through a hole threaded in the conducting structural element (1).

9. STRAP CONNECTION DEVICE FOR ELECTRICAL CONDUCTIVITY, according to claim 1, characterized in that the clamping element to one of the cable ends of a pluggable part is provided for as an extension of the displaceable mechanism (6) of the quick-release connector (3), in order to carry out the release when acting on the cable.

10. STRAP CONNECTION DEVICE FOR ELECTRICAL CONDUCTIVITY, according to claim 1, characterized in that it is applicable to conducting structural elements (1) wherein there is relative movement.

11. STRAP CONNECTION DEVICE FOR ELECTRICAL CONDUCTIVITY, according to claim 2, characterized in that the coupling tolerance of the pluggable parts (4 and 5) of the quick-release connector (3) is such that it allows a slight relative angular displacement between them, to avoid twists on the conductor cable.

12. STRAP CONNECTION DEVICE FOR ELECTRICAL CONDUCTIVITY, according to claim 1, characterized in that it is applicable in the aeronautical industry to the straps (2) provided for to conduct the lightning that may strike an aircraft.

13. STRAP CONNECTION DEVICE FOR ELECTRICAL CONDUCTIVITY, according to claim 3, characterized in that the pluggable parts (4 and 5) of the quick-release connector (3) have outside surfaces (18 and 19) which in the connected position face each other and are separated at a certain distance (16), wherein a water-tight sealing gasket 17 of the pluggable parts (4 and 5) is provided for.

14. STRAP CONNECTION DEVICE FOR ELECTRICAL CONDUCTIVITY, according to claim 3, characterized in that the pluggable parts (4 and 5) of the quick-release connector (3) have outside surfaces (18 and 19) which in the connected position face each other and are in contact, wherein a water-tight sealing gasket (17) of the pluggable parts (4 and 5) is provided for.

15. STRAP CONNECTION DEVICE FOR ELECTRICAL CONDUCTIVITY, according to claim 2, characterized in that the clamping element to one of the cable ends of a pluggable part is provided for as an extension of the displaceable mechanism (6) of the quick-release connector (3), in order to carry out the release when acting on the cable.

16. STRAP CONNECTION DEVICE FOR ELECTRICAL CONDUCTIVITY, according to claim 3, characterized in that the clamping element to one of the cable ends of a pluggable part is provided for as an extension of the displaceable mechanism (6) of the quick-release connector (3), in order to carry out the release when acting on the cable.

17. STRAP CONNECTION DEVICE FOR ELECTRICAL CONDUCTIVITY, according to claim 4, characterized in that the clamping element to one of the cable ends of a pluggable part is provided for as an extension of the displaceable mechanism (6) of the quick-release connector (3), in order to carry out the release when acting on the cable.

18. STRAP CONNECTION DEVICE FOR ELECTRICAL CONDUCTIVITY, according to claim 5, characterized in that the clamping element to one of the cable ends of a pluggable part is provided for as an extension of the displaceable mechanism (6) of the quick-release connector (3), in order to carry out the release when acting on the cable.

19. STRAP CONNECTION DEVICE FOR ELECTRICAL CONDUCTIVITY, according to claim 6, characterized in that the clamping element to one of the cable ends of a pluggable part is provided for as an extension of the displaceable mechanism (6) of the quick-release connector (3), in order to carry out the release when acting on the cable.

20. STRAP CONNECTION DEVICE FOR ELECTRICAL CONDUCTIVITY, according to claim 7, characterized in that the clamping element to one of the cable ends of a pluggable part is provided for as an extension of the displaceable mechanism (6) of the quick-release connector (3), in order to carry out the release when acting on the cable.

21. STRAP CONNECTION DEVICE FOR ELECTRICAL CONDUCTIVITY, according to claim 3, characterized in that the coupling tolerance of the pluggable parts (4 and 5) of the quick-release connector (3) is such that it allows a slight relative angular displacement between them, to avoid twists on the conductor cable.

22. STRAP CONNECTION DEVICE FOR ELECTRICAL CONDUCTIVITY, according to claim 10, characterized in that the coupling tolerance of the pluggable parts (4 and 5) of the quick-release connector (3) is such that it allows a slight relative angular displacement between them, to avoid twists on the conductor cable.

23. STRAP CONNECTION DEVICE FOR ELECTRICAL CONDUCTIVITY, according to claim 10, characterized in that it is applicable in the aeronautical industry to the straps (2) provided for to conduct the lightning that may strike an aircraft.
